(19) United States
(12) Patent Application Publication
(10) Pub. No.: US 2024/0369455 A1
(43) Pub. Date: Nov. 7, 2024

(54) ESTIMATION OF VERTICAL LOAD ACTING ON A TIRE AS A FUNCTION OF TIRE INFLATION PRESSURE

(71) Applicant: Bridgestone Americas Tire Operations, LLC, Nashville, TN (US)

(72) Inventors: Thomas A. Sams, Akron, OH (US); Mallikarjun Avula, Akron, OH (US); Michael F. Gessner, Akron, OH (US); Patrick R. Moga, Akron, OH (US)

(21) Appl. No.: 18/565,512

(22) PCT Filed: Jul. 26, 2022
(86) PCT No.: PCT/US2022/074125

§ 371 Date: Nov. 29, 2023

Related U.S. Application Data
(60) Provisional application No. 63/237,632, filed on Aug. 27, 2021.

(51) Int. Cl. G01M 17/02; B60C 23/06

(52) U.S. Cl. CPC G01M 17/02; B60C 23/061

(57) ABSTRACT

Systems (100) and methods (200) are provided for estimating at least a load acting on a vehicle-mounted tire (122). In an embodiment, tire-mounted sensor (118) generates output signals corresponding to at least tire inflation pressure and footprint length. A linear model between load and footprint length for the tire is retrievably stored (214, 224), along with derived model coefficients as a function of at least sensed tire inflation pressure. Local controller (102), remote server (130), or other computing device (140) is linked to tire-mounted sensor and data storage (106, 134), and further configured to estimate the load (230) acting upon the tire from the linear model, based on at least footprint length, sensed tire inflation pressure, and the derived model coefficients (222), and to generate an output signal corresponding to the estimated load (240) for display (242, 244), wear detection (246), traction detection (248), or other control functions.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### FIELD OF THE DISCLOSURE

The present disclosure relates generally to quantifying performance aspects of tires on wheeled motor vehicles. More particularly, systems, methods, and related algorithms as disclosed herein relate to the estimation of vertical load acting on tires of wheeled motor vehicles including but not limited to motorcycles, consumer vehicles (e.g., passenger and light truck), commercial and off-road (OTR) vehicles, and various performance aspects of such vehicles based on an improved vertical load estimation, wherein the load estimation is a function of tire inflation pressure as provided substantially in real time from tire-mounted sensors.

### BACKGROUND

Various operational conditions such as the load, inclination angle, and slip angle on a tire are conventionally understood to be vital pieces of information for understanding performance aspects such as the wear, health, and tractional potential of the tire.

Prediction of such performance aspects is accordingly an important tool for anyone owning or operating vehicles, particularly in the context of fleet management. As tires are used, it is normal for the tread to gradually become shallower and overall tire performance to change. At a certain point it becomes critical to be aware of the tire conditions, as insufficient tire tread can create unsafe driving conditions. For example, when road conditions are non-optimal the tires may be unable to grip the road and a driver may lose control of his or her vehicle. Generally stated, the shallower the tire tread, the more easily the driver may lose traction when driving in rain, snow, or the like.

Typical on-vehicle sensor measurements for a vehicle such as a heavy truck may include vehicle speed, radial acceleration, ambient temperature, tire inflation pressure, and tire contained air temperature (CAT). These measurements are all vital when extending them to higher order predictions such as wear and durability. However, one of the most important pieces of information is still typically missing—the load acting upon the tire, conventional sensors for which may be prohibitively expensive and/or unreliable.

### BRIEF SUMMARY

In view of the aforementioned deficiencies in conventional systems, approaches as disclosed herein may be implemented to estimate operational condition indicators, such as for example the load acting upon the tire, that are vital to understanding the wear, durability, traction, and other performance criteria of the tire. A system configured accordingly may comprise a tire-mounted sensing unit and novel algorithms to provide users such as for example fleet management entities with real-time monitoring and predictive analysis.

Exemplary implementations of the present disclosure may improve upon the accuracy of conventional algorithms by adding a tire inflation pressure dependency. One particular example of a model within the scope of the present disclosure includes the following algorithm:

$${F}_{z} = {m}_{2} ( FP L ) + {m}_{1} ( p ) - b$$

The above algorithm considers a footprint length (FPL) as reported for example from a tire-mounted sensor (TMS) and an inflation pressure (p) as may also be reported from the TMS, along with three model coefficients derived from data collected at a known force (Fz) applied to the tire. The model coefficients may be tire specific. The above algorithm, having been developed with the model coefficients, may be implemented during real-time operation based on TMS inputs to calculate the force being currently applied, i.e., weight of the vehicle on the tire.

An exemplary embodiment of a method as disclosed herein may be provided for estimating at least a load acting upon a tire mounted on a vehicle. At least one sensor mounted on the tire provides at least signals representative of a sensed tire inflation pressure and a footprint length (or other parameters from which the footprint length may be determined). A linear model between a load and the footprint length for the tire is retrieved from data storage, along with at least a first model coefficient as a function of the sensed tire inflation pressure. The load acting upon the tire is estimated from the linear model, based on at least the footprint length, the sensed tire inflation pressure, and the at least first model coefficient as a function of the sensed tire inflation pressure. An output signal is generated corresponding to the estimated load acting on the tire.

In one exemplary aspect according to the above-referenced embodiment, signals are obtained from the at least one tire-mounted sensor representative of a radial acceleration, wherein the footprint length associated with the tire is calculated based at least in part on the signals as representative of the radial acceleration.

In another exemplary aspect according to the above-referenced embodiment, the at least first model coefficient comprises a first model coefficient as an offset coefficient as a function of the sensed tire inflation pressure, and a second model coefficient as a slope coefficient as a function of the sensed tire inflation pressure. The load acting upon the tire is estimated from the linear model based on at least the footprint length, the sensed tire inflation pressure, the first model coefficient, and the second model coefficient.

In another exemplary aspect according to the above-referenced embodiment, the load acting upon the tire is estimated from the linear model further based on a third model coefficient as a slope coefficient relating footprint length to tire load at a nominal tire inflation pressure.

In another exemplary aspect according to the above-referenced embodiment, the linear model is generated by, during an operation comprising known input values for tire inflation pressure, vertical load, and velocity: monitoring input signals representative of a footprint length from a sensor mounted on a tire; calculating the at least first model coefficient in accordance with a linear correlation between the vertical load and the footprint length at the known tire inflation pressure; and retrievably storing the at least first model coefficient as a function of the known tire inflation pressure.

In another exemplary aspect according to the above-referenced embodiment, the output signal is provided to a user interface associated with the vehicle for display to a user of the vehicle.

In another exemplary aspect according to the above-referenced embodiment, the output signal is provided to a user interface associated with a remote computing device via a fleet management telematics platform.

In another exemplary aspect according to the above-referenced embodiment, the estimated load is utilized as an input to a tire wear detection model. The estimated load and/or an estimated tire wear based at least in part on the estimated load may further be utilized as an input to a tire traction detection model. The estimated tire wear based at least in part on the estimated load and/or an estimated tire traction based at least in part on the estimated tire wear may further be provided to a vehicle control unit such as for example an active safety unit.

In another embodiment, a system is disclosed herein for estimating at least a load acting on at least one tire mounted on a vehicle. At least one tire-mounted sensor is configured to generate output signals corresponding to at least a tire inflation pressure and a footprint length. Retrievably stored in data storage is a linear model between a load and the footprint length for the tire, and at least a first model coefficient as a function of the sensed tire inflation pressure. A local controller, remote server, and/or other appropriate computing device is communicatively linked to the at least one tire-mounted sensor and the data storage, and further configured to direct the performance of remaining steps or operations from the above-referenced method embodiment and optionally any of the described exemplary aspects thereof.

### BRIEF DESCRIPTION OF THE SEVERAL VIEWS OF THE DRAWINGS

Hereinafter, embodiments of the invention are illustrated in more detail with reference to the drawings.

FIG. 1 is a block diagram representing an embodiment of a tire load estimation system as disclosed herein.

FIG. 2 is a flowchart representing an embodiment of a tire load estimation method as disclosed herein.

FIG. 3 is a graphical diagram representing an exemplary model coefficient (e.g., offset coefficient, or intercept) as a function of tire inflation pressure.

FIG. 4 is a graphical diagram representing an exemplary comparison of a measured load acting upon a tire with respect to a predicted load for model validation.

### DETAILED DESCRIPTION

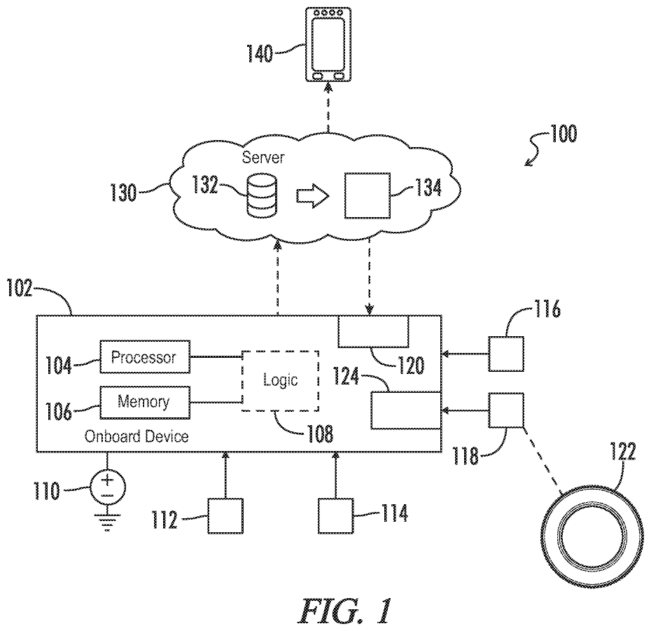

Referring generally to FIGS. 1-4, various exemplary embodiments of an invention may now be described in detail. Where the various figures may describe embodiments sharing various common elements and features with other embodiments, similar elements and features are given the same reference numerals and redundant description thereof may be omitted below. A system 100 according to certain embodiments may include, and/or a method 200 according to certain embodiments may be executed by, a computing device 102 that is local and for example resides in association with a vehicle, or a computing device 130, 140 that is remote and for example is part of a cloud-based network or a fleet management system, or some combination thereof within the scope of the present disclosure. Centralized or distributed data processing may accordingly be implemented based on inputs from specified sensors, or to at least initiate the generation of output signals are further described herein to specified interfaces, control systems, or actuators, without limitation unless otherwise specifically stated.

Referring initially to FIG. 1, one exemplary embodiment of a system 100 as disclosed herein includes a data acquisition device 102 that is onboard a vehicle and configured to perform relevant computations as disclosed herein, and/or to at least obtain data and transmit said data to one or more downstream computing devices (e.g., a remote server 130) to perform relevant computations as disclosed herein. The data acquisition device may be a standalone sensor unit (not shown) appropriately configured to collect raw measurement signals, such as for example signals corresponding to a tire's radial acceleration, contained air temperature, and/or internal inflation pressure, and to continuously or selectively transmit such signals to downstream computing devices. The data acquisition device 102 may comprise an onboard computing device 102 in communication with one or more distributed sensors and which is portable or otherwise modular as part of a distributed vehicle data collection and control system, or otherwise may be integrally provided with respect to a central vehicle data collection control system. The data acquisition device 102 may include a processor 104 and memory 106 having program logic 108 residing thereon, and in various embodiments may comprise a vehicle electronic control unit (ECU) or a component thereof, or otherwise may be discrete in nature, for example permanently or detachably provided with respect to a vehicle mount.

Generally stated, a system 100 as disclosed herein may implement numerous components distributed across one or more vehicles, for example but not necessarily associated with a fleet management entity, and further a central server network or event-driven serverless platform in functional communication with each of the vehicles via a communications network.

The illustrated embodiment may include for illustrative purposes, without otherwise limiting the scope of the present invention thereby, a tire-mounted sensor unit 118, an ambient temperature sensor 112, a vehicle speed sensor 114 configured to collect for example acceleration data associated with the vehicle, position sensors 116 such as global positioning system (GPS) transponders, and a DC power source 110. The tire mounted sensor unit 118 may include one or more sensors mounted to an inner liner of the tire, to a valve of the tire, or the like, and configured to generate output signals corresponding to tire conditions including any or all of radial acceleration, contained air temperature, inflation pressure, and the like, and such sensors may take any of various forms known to one of skill in the art for providing such signals. Various bus interfaces, protocols, and associated networks are well known in the art for the communication between the respective data sources and the local computing device 102 and/or servers 130, including for example an onboard receiver 124, and one of skill in the art would recognize a wide range of such tools and means for implementing the same.

In some embodiments, data acquisition devices and equivalent data sources as disclosed herein are not necessarily limited to vehicle-specific sensors and/or gateway devices and can also include third party entities and associated networks, program applications resident on a user computing device 140 such as a driver interface, a fleet management interface, and any enterprise devices or other providers of raw streams of logged data as may be considered relevant for algorithms and models as disclosed herein.

In some embodiments, one or more of the various sensors 112, 114, 116, 118 may be configured to communicate with downstream platforms without a local vehicle-mounted device or gateway components, such as for example via cellular communication networks or via a mobile computing device (not shown) carried by a user of the vehicle.

The term “user interface” as used herein may, unless otherwise stated, include any input-output module by which a user device facilitates user interaction with respect to a processing unit, server, device, or the like as disclosed herein including, but not limited to: downloaded or otherwise resident program applications; web browsers; web portals, such as individual web pages or those collectively defining a hosted website; and the like. A user interface may further be described with respect to a personal mobile computing device in the context of buttons and display portions which may be independently arranged or otherwise interrelated with respect to, for example, a touch screen, and may further include audio and/or visual input/output functionality even without explicit user interactivity.

Vehicle and tire sensors 112, 114, 116, 118, etc., may in an embodiment further be provided with unique identifiers, wherein an onboard device processor can distinguish between signals provided from respective sensors on the same vehicle, and further in certain embodiments wherein a central processing unit and/or fleet maintenance supervisor client device may distinguish between signals provided from tires and associated vehicle and/or tire sensors across a plurality of vehicles. In other words, sensor output values may in various embodiments be associated with a particular tire, a particular vehicle, and/or a particular tire-vehicle system for the purposes of onboard or remote/downstream data storage and implementation for calculations as disclosed herein. An onboard data acquisition device 102 may communicate directly with the downstream processing stage 130 as shown in FIG. 1, or alternatively the driver's mobile device or truck-mounted computing device may be configured to receive and process/transmit onboard device output data to one or more downstream processing units.

Raw signals received from a tire-mounted sensor 118, whether mounted to an inner liner of the tire or a valve of the tire or the like, may optionally be stored in onboard device memory 106, or an equivalent local data storage network functionally linked to the onboard device processor 104, for selective retrieval and transmittal via a data pipeline stage as needed for calculations according to the method disclosed herein. A local or downstream “data storage network” as used herein may refer generally to individual, centralized, or distributed logical and/or physical entities configured to store data and enable selective retrieval of data therefrom, and may include for example but without limitation a memory, look-up tables, files, registers, databases, database services, and the like. In some embodiments, raw data signals from the various sensors 112, 114, 116, 118 may be communicated substantially in real time from the vehicle to a downstream processing unit such as server 130. Alternatively, particularly in view of the inherent inefficiencies in continuous data transmission of high frequency data, the data may for example be compiled, encoded, and/or summarized for more efficient (e.g., periodic time-based or alternatively defined event-based) transmission from the sensors or an onboard device (i.e., associated with the vehicle) to a remote processing unit via an appropriate (e.g., cellular) communications network.

The vehicle data and/or tire data, once transmitted via a communications network to a downstream server 130 or equivalent processing system, may be stored for example in a database 132 associated therewith and further processed or otherwise retrievable as inputs for processing via one or more algorithmic models 134 as disclosed herein. The models 134 may be implemented at least in part via execution of a processor, enabling selective retrieval of the vehicle data and/or tire data and further in electronic communication for the input of any additional data or algorithms from a database, lookup table, or the like that is stored in association with the processing unit.

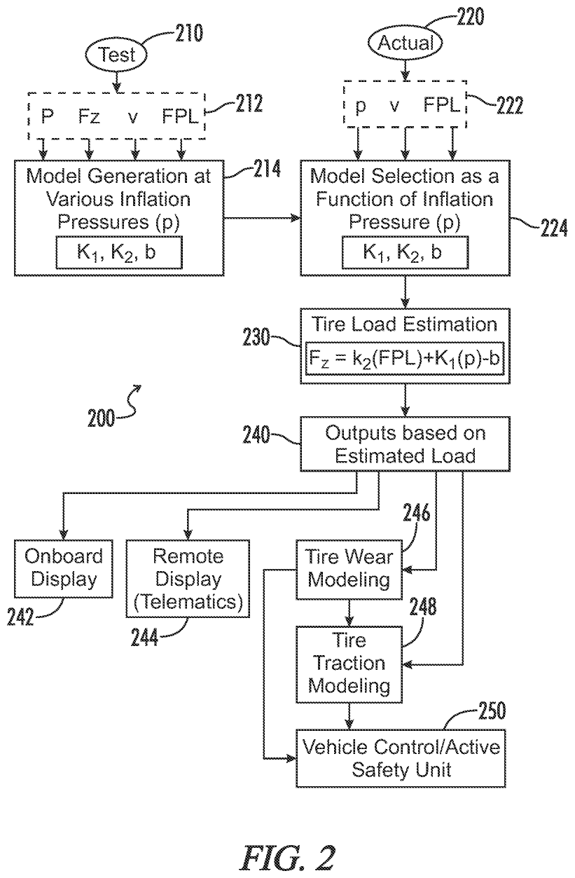

Referring hereafter to FIGS. 2-4, various embodiments of a method 200 may now be described for estimating at least a vertical load acting upon at least one tire mounted on a vehicle. Embodiments of a method 200 may either or both of a testing and model generation stage (210-214) and a model implementation stage (220-250), or portions or variations thereof within the scope of the present disclosure. Otherwise stated, models as disclosed herein may initially be generated and subsequently implemented and/or modified by a given entity, or an entity may merely selectively retrieve models for implementation that have been generated by another.

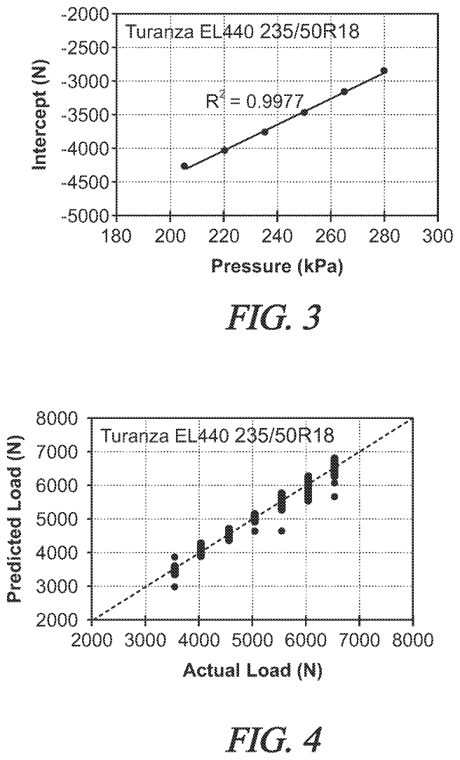

Referring initially (at step 210) to the testing and model generation stage, various inputs are provided (step 212) for data processing and the generation (in step 214) of one or more model coefficients specific to the tire being tested. In one example, data as represented in FIGS. 3 and 4 were collected through offline testing, wherein model generation inputs were tire inflation pressure (p), vertical load (Fz), and speed (v). Additional data corresponding to footprint length (FPL) may be received as inputs from a tire-mounted sensor on the tested tire, for example as a direct input or calculated based on other inputs such as radial acceleration. As represented in FIG. 3, a clear linear relationship was identified between a vertical load applied to the tire and a footprint length of the tire at various inflation pressures. This data was then used to create an exemplary algorithm as follows:

$${F}_{z} = {m}_{2} ( FP L ) + {m}_{1} ( p ) - b$$

With this algorithm a linear relationship is demonstrated between vertical load acting on the tire and footprint length, at various inflation pressures. The model coefficients m₁ and b in this example are each related to and dependent on the tire inflation pressure. The model coefficient m₂ in this example relates footprint length to tire load at a nominal tire inflation pressure.

Referring next (at step 210) to a subsequent or alternative actual vertical load estimation stage, the generated models may in various embodiments be implemented substantially in real time based on actual inputs during operation of the tire or associated type of tire. Actual inputs collected during operation (step 222) may typically include at least a sample tire inflation pressure (p) and values corresponding to a footprint length (FPL).

In certain embodiments, the footprint length may be collected directly from the TMS device. In one alternative embodiment, data corresponding to an acceleration waveform of a tire may be collected in a tire radial direction from sampled outputs of a tire-mounted sensor. The acceleration waveform may then be integrated in the tire radial direction to generate a velocity waveform, wherein a number of samples during ground contact are calculated from at least first and second peaks in the velocity waveform. From a physical understanding of the velocity (integrated acceleration) profile, one of skill in the art may appreciate that the entrance and exit of the ground contact patch (footprint) are identifiable as corresponding with a difference in the number of samples between first and second waveform peaks of the integrated accelerometer signal, accordingly corresponding with the number of samples taken in the footprint area. A length of the ground contact patch, or footprint length, may further be calculated based on at least the calculated number of samples during ground contact, a sampling rate of the outputs of the tire-mounted sensor, and a velocity (r) of the vehicle.

The inputs (e.g., p and FPL) may be fed into a model selection stage wherein for example model coefficients (e.g., m₁, m₂, b) are selected depending on the tire inflation pressure (step 224). The model selection may be implemented at least based in part on the tire inflation pressure, and in some embodiments may further be implemented based at least in part on for example a wheel mounting position of the tire at issue, in view of any known or predicted relevant dependencies of the applied load based on such wheel mount distinctions. The tire load may then be estimated for example based on the above-referenced algorithm, further in view of at least the selected model coefficients (step 230).

The method 200 may further continue wherein an output signal is generated corresponding to the estimated load acting upon the tire (step 240). In various embodiments, the output signal may be provided to a user interface associated with the vehicle for local display to a user of the vehicle (step 242), and/or a user interface associated with a remote computing device via for example a fleet management telematics platform (step 244), and/or a vehicle control unit. In the case where the output signal is provided to a vehicle control unit, the estimated load may for example be utilized as an input to a tire wear estimation model (step 246), and/or to a tire traction estimation model (step 248).

An exemplary tire wear model may estimate tire wear values based on, e.g., “digital twin” virtual representations of various physical parts, processes or systems wherein digital and physical data is paired and combined with learning systems such as for example neural networks. For example, the above-referenced output signals and associated location/route information may be provided to generate a digital representation of the vehicle tire for estimation of tire wear, wherein subsequent comparison of the estimated tire wear with a determined actual tire wear may be implemented as feedback for the machine learning algorithms. The wear model may be implemented at the vehicle, for processing via the onboard system, or the tire data and/or vehicle data may be processed to provide representative data to the hosted server for remote wear estimation.

In various embodiments, the method may further involve predicting wear values at one or more future points in time, wherein such predicted values may be compared to respective threshold values. For example, a feedback signal corresponding to the predicted tire wear status (e.g., predicted tread depth at a given distance, time, or the like) may be provided via an interface to an onboard device associated with the vehicle itself, or to a mobile device associated with a user, such as for example integrating with a user interface configured to provide alerts or notice/recommendations that a tire should or soon will need to be replaced. Other tire-related threshold events can be predicted and implemented for alerts and/or interventions within the scope of the present disclosure and based on predicted tire wear, including for example tire rotation, alignment, inflation, and the like. The system may generate such alerts and/or intervention recommendations based on individual thresholds, groups of thresholds, and/or non-threshold algorithmic comparisons with respect to predetermined parameters.

As another example, a wear model may enable fleet management systems to track performance of not only specific vehicles and tires, but associated routes, drivers, and the like. Using the predicted wear rates obtained via the methods herein, a fleet manger may for example ascertain which trucks, drivers, routes, and/or tire models are burning through tread the fastest, or conversely, saving tread. Furthermore, accurate wear modeling may preferably provide decision support with respect to fleet tire purchasing. Tire wear-out prediction may for example be aggregated into a projected tire purchase estimation model for a given year, month, week, or the like.

As another example, an autonomous vehicle fleet may comprise numerous vehicles having varying minimum tread status values, wherein the fleet management system may be configured to proactively disable deployment of vehicles falling below a minimum threshold. The fleet management system may further implement varying minimum tread status values corresponding to wheel positions. The system may accordingly be configured to act upon a minimum tire tread value for each of a plurality of tires associated with a vehicle, or in an embodiment may calculate an aggregated tread status for the plurality of tires for comparison against a minimum threshold.

A tire wear status (e.g., tread depth) may for example be provided along with the above-referenced output signals as inputs to a traction model (step 248), which may be configured to provide an estimated traction status or one or more traction characteristics for the respective tire. As with the aforementioned wear model, the traction model may comprise “digital twin” virtual representations of physical parts, processes or systems wherein digital and physical data are paired and combined with learning systems such as for example artificial neural networks. Real vehicle data and/or tire data from a particular tire, vehicle or tire-vehicle system may be provided throughout the life cycle of the respective asset to generate a virtual representation of the vehicle tire for estimation of tire traction, wherein subsequent comparison of the estimated tire traction with a corresponding measured or determined actual tire traction may preferably be implemented as feedback for machine learning algorithms executed at a server level.

The traction model may in various embodiments utilize the results from prior testing, including for example stopping distance testing results, tire traction testing results, etc., as collected with respect to numerous tire-vehicle systems and associated combinations of values for input parameters (e.g., tire tread, inflation pressure, road surface characteristics, vehicle speed and acceleration, slip rate and angle, normal force, braking pressure and load), wherein a tire traction output may be effectively predicted for a given set of current vehicle data and tire data inputs.

In one embodiment, outputs from this traction model may be incorporated into an active safety system (step 250). The term “active safety system” as used herein may preferably encompass such systems as are generally known to one of skill in the art, including but not limited to examples such as collision avoidance systems, advanced driver-assistance systems (ADAS), anti-lock braking systems (ABS), etc., which can be configured to utilize the traction model output information to achieve optimal performance. For example, collision avoidance systems are typically configured to take evasive action, such as automatically engaging the brakes of a host vehicle to avoid or mitigate a potential collision with a target vehicle, and enhanced information regarding the traction capabilities of the tires and accordingly the braking capabilities of the tire-vehicle system are eminently desirable.

In another embodiment (not shown), a ride-sharing autonomous fleet could use output data from the traction model to disable or otherwise selectively remove vehicles with low tread depth from use during inclement weather, or potentially to limit their maximum speeds.

In some embodiments, the method 200 may also involve providing inputs such as the estimated forces acting on the tire, the estimated wear, alone or in combination with other relevant metrics of severity of use of the tire, as inputs to a tire durability and health model. Such a model may be implemented for estimating relative fatigue characteristics, for example as an indicator of durability events such as tread/belt separations. Such a model may also for example be implemented for estimating relative tire aging characteristics or predicting wear state at one or more future points in time. Feedback signals corresponding to such durability events may be provided via an interface to an onboard device 102 associated with the vehicle itself, or to a mobile device associated with a user, such as for example integrating with a user interface configured to provide alerts or notice/recommendations of an intervention event, such as for example that one or more tires should or soon will need to be replaced, rotated, aligned, inflated, and the like. Outputs from a tire durability and health model may further or in the alternative be provided to the traction model referenced above.

Throughout the specification and claims, the following terms take at least the meanings explicitly associated herein, unless the context dictates otherwise. The meanings identified below do not necessarily limit the terms, but merely provide illustrative examples for the terms.

The meaning of “a,” “an,” and “the” may include plural references, and the meaning of “in” may include “in” and “on.”

The phrase “in one embodiment,” as used herein does not necessarily refer to the same embodiment, although it may.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Whereas certain preferred embodiments of the present invention may typically be described herein with respect to methods executed by or on behalf of fleet management systems and more particularly for autonomous vehicle fleets or commercial trucking applications, the invention is in no way expressly limited thereto and the term “vehicle” as used herein unless otherwise stated may refer to an automobile, truck, or any equivalent thereof, whether self-propelled or otherwise, as may include one or more tires and therefore require accurate estimation or prediction of tire internal air pressure loss and potential disabling, replacement, or intervention.

The term “user” as used herein unless otherwise stated may refer to a driver, passenger, mechanic, technician, fleet management personnel, or any other person or entity as may be, e.g., associated with a device having a user interface for providing features and steps as disclosed herein.

The previous detailed description has been provided for the purposes of illustration and description. Thus, although there have been described particular embodiments of a new and useful invention, it is not intended that such references be construed as limitations upon the scope of this invention except as set forth in the following claims.

1-11. (canceled)

12. A method for estimating at least a load acting upon a tire mounted on a vehicle, the method comprising:
during respective test operations comprising known input values for tire inflation pressure, vertical load, and velocity, generating one or more linear models correlating vertical load and footprint length by:
monitoring input signals representative of a footprint length from a sensor mounted on a tire corresponding to the test operation;
calculating the at least first model coefficient in accordance with a linear correlation between the vertical load and the footprint length at the known tire inflation pressure; and
retrievably storing the at least first model coefficient as a function of the known tire inflation pressure;
wherein the method further comprises, during an actual operation including at least a first tire mounted on the vehicle:
obtaining at least signals representative of a sensed tire inflation pressure from a sensor mounted on the first tire;
determining a footprint length associated with the first tire;
retrieving from data storage a linear model corresponding to the determined footprint length for the first tire, and at least a first model coefficient as a function of the sensed tire inflation pressure;
estimating the load acting upon the first tire from the linear model, based on at least the footprint length, the sensed tire inflation pressure, and the at least first model coefficient as a function of the sensed tire inflation pressure; and
generating an output signal corresponding to the estimated load acting on the first tire.

13. The method of claim 12, further comprising obtaining at least signals representative of a radial acceleration from the sensor mounted on the tire, and calculating the footprint length associated with the tire based at least in part on the signals representative of the radial acceleration.

14. The method of claim 12, wherein:
the at least first model coefficient comprises a first model coefficient as an offset coefficient as a function of the sensed tire inflation pressure, and a second model coefficient as a slope coefficient as a function of the sensed tire inflation pressure, and
the load acting upon the tire is estimated from the linear model based on at least the footprint length, the sensed tire inflation pressure, the first model coefficient, and the second model coefficient.

15. The method of claim 14, wherein the load acting upon the tire is estimated from the linear model further based on a third model coefficient as a slope coefficient relating footprint length to tire load at a nominal tire inflation pressure.

16. The method of claim 12, wherein the output signal is provided to a user interface associated with the vehicle for display to a user of the vehicle.

17. The method of claim 12, wherein the output signal is provided to a user interface associated with a remote computing device via a fleet management telematics platform.

18. The method of claim 12, wherein the estimated load is utilized as an input to a tire wear detection model.

19. The method of claim 18, wherein the estimated load and/or an estimated tire wear based at least in part on the estimated load is utilized as an input to a tire traction detection model.

20. The method of claim 19, wherein the estimated tire wear based at least in part on the estimated load and/or an estimated tire traction based at least in part on the estimated tire wear is provided to a vehicle control unit.

21. A system for estimating at least a load acting on at least one tire mounted on a vehicle, the system comprising:
at least one tire-mounted sensor configured to generate output signals corresponding to at least a tire inflation pressure and a footprint length;
data storage having stored thereon one or more linear models correlating vertical loads and footprint lengths based on test operations performed on tires, and at least a first model coefficient calculated as a function of a linear correlation between vertical load and footprint length at known tire inflation pressures; and
a computing device is communicatively linked to the at least one tire-mounted sensor and the data storage, and further configured to
estimate the load acting upon the tire from a selected linear model, based on at least the footprint length, the sensed tire inflation pressure, and the at least first model coefficient as a function of the sensed tire inflation pressure; and
generate an output signal corresponding to the estimated load acting on the tire.

22. The system of claim 21, wherein the at least one tire-mounted sensor generates signals representative of a radial acceleration, and the computing device calculates the footprint length associated with the tire based at least in part on the signals representative of the radial acceleration.

23. The system of claim 21, wherein:
the at least first model coefficient comprises a first model coefficient as an offset coefficient as a function of the sensed tire inflation pressure, and a second model coefficient as a slope coefficient as a function of the sensed tire inflation pressure, and
the load acting upon the tire is estimated from the linear model based on at least the footprint length, the sensed tire inflation pressure, the first model coefficient, and the second model coefficient.

24. The system of claim 23, wherein the load acting upon the tire is estimated from the linear model further based on a third model coefficient as a slope coefficient relating footprint length to tire load at a nominal tire inflation pressure.

25. The system of claim 21, wherein the output signal is provided to a user interface associated with the vehicle for display to a user of the vehicle.

26. The system of claim 21, wherein the output signal is provided to a user interface associated with a remote computing device via a fleet management telematics platform.

27. The system of claim 21, wherein the estimated load is utilized as an input to a tire wear detection model.

28. The system of claim 27, wherein the estimated load and/or an estimated tire wear based at least in part on the estimated load is utilized as an input to a tire traction detection model.

29. The system of claim 28, wherein the estimated tire wear based at least in part on the estimated load and/or an estimated tire traction based at least in part on the estimated tire wear is provided to a vehicle control unit.
